(19) United States
(12) Patent Application Publication
(10) Pub. No.: US 2026/0052439 A1
(43) Pub. Date: Feb. 19, 2026

(54) TECHNOLOGIES FOR CONTROL PLANE IN CENTRALIZED UNIT - DISTRIBUTED UNIT SPLIT ARCHITECTURE

(71) Applicant: Apple Inc., Cupertino, CA (US)

(72) Inventors: Fangli Xu, Beijing (CN); Haijing Hu, Los Gatos, CA (US); Naveen Kumar R. Palle Venkata, San Diego, CA (US); Peng Cheng, Beijing (CN); Ralf Rossbach, Munich (DE); Shu Guo, Beijing (CN); Yuqin Chen, Beijing (CN); Zhibin Wu, Los Altos, CA (US)

(73) Assignee: Apple Inc., Cupertino, CA (US)

(21) Appl. No.: 19/271,601

(22) Filed: Jul. 16, 2025

Related U.S. Application Data
(60) Provisional application No. 63/684,252, filed on Aug. 16, 2024.

(51) Int. Cl. H04W 36/06; H04W 36/00; H04W 36/30

(52) U.S. Cl. CPC H04W 36/06; H04W 36/0064; H04W 36/30

(57) ABSTRACT

The present application relates to devices and components including apparatus, systems, and methods for control plane (CP) operations in a split centralized unit (CU)—distributed unit (DU) architecture.

### CROSS-REFERENCE TO RELATED APPLICATION

This application claims the benefit of U.S. Provisional Patent Application No. 63/684,252, filed on Aug. 16, 2024, which is herein incorporated by reference in its entirety for all purposes.

### TECHNICAL FIELD

This application relates generally to communication networks and, in particular, to technologies for control plane in centralized unit—distributed unit split architecture.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example service-based architecture in accordance with some embodiments.

FIG. 3 illustrates an example network environment in accordance with some embodiments.

FIG. 4 illustrates example aspects of a user equipment, a distributed unit, and a centralized unit, in accordance with some embodiments.

FIG. 5A illustrates an example procedure in accordance with some embodiments.

FIG. 5B illustrates another example procedure in accordance with some embodiments.

FIG. 5C illustrates another example procedure in accordance with some embodiments.

FIG. 6A illustrates another example procedure in accordance with some embodiments.

FIG. 6B illustrates another example procedure in accordance with some embodiments.

FIG. 7 illustrates another example procedure in accordance with some embodiments.

FIG. 8A illustrates another example procedure in accordance with some embodiments.

FIG. 8B illustrates another example procedure in accordance with some embodiments.

FIG. 9 illustrates another example procedure in accordance with some embodiments.

FIG. 10 illustrates another example procedure in accordance with some embodiments.

FIG. 11 illustrates another example procedure in accordance with some embodiments.

FIG. 12 illustrates an operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

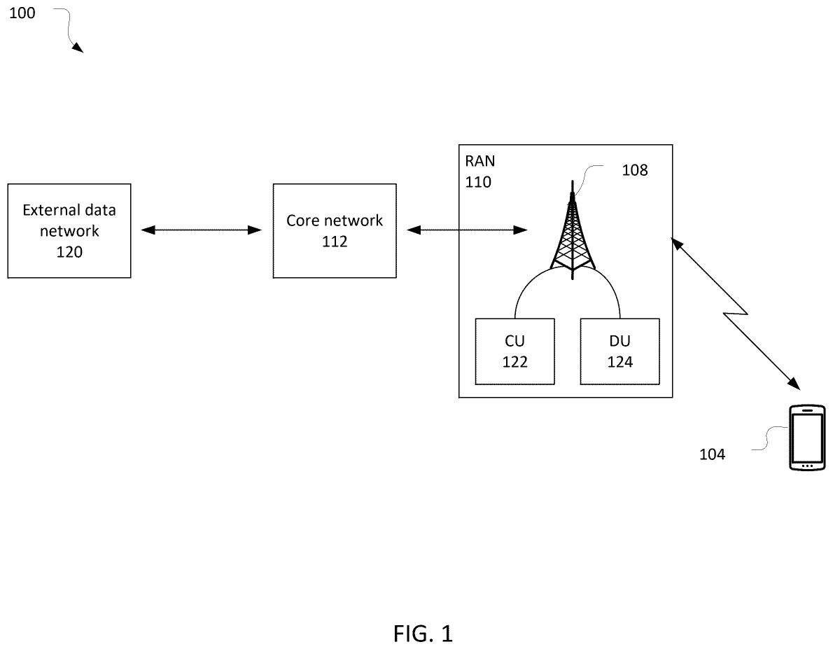

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane and control plane protocol terminations toward the UE 104.

The network environment 100 may further include a core network (CN) 112. For example, the CN 112 may comprise a 5^{th} Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120, which may be accessed by the UE 104 via the RAN 110.

In various embodiments, the base station 108 may include a split architecture that includes a centralized unit (CU) 122 and a distributed unit (DU) 124. In some embodiments, a plurality of DUs, including DU 124 may be coupled to the same CU 122, e.g., as discussed further below. In general, the CU 122 may handle higher-layer protocols, for example, radio resource control (RRC), packet data convergence (PDCP), and service data adaptation protocol (SDAP) layer protocols, while the DU 124 handles lower-layer protocols, for example, radio link control (RLC), media access control (MAC), and physical (PHY) layer protocols. However, as discussed further below, some embodiments herein provide techniques to split the RRC functionality between the CU 122 and DU 124.

The CU 122 may provide control-plane (CP) functionality by, for example, a CU-CP component, and user-plane (UP) functionality by, for example, a CU-UP component. In some embodiments, the DU 124 may additionally provide CP functionality by, for example, a DU-control (C) component, and UP functionality by, for example, a DU-user (U) component.

In 5G, a service-based architecture (SBA) was standardized for the core network control plane. Additionally, in 5G, all CP functions, such as radio resource management (RRM), radio bearer (RB) control, mobility, access control, and measurement configuration and provision are located in the CU.

Future systems, such as 6G systems, may enable flexibility in where the CU is deployed within the network environment. For example, the CU may be deployed at the edge of the RAN or in the CN. In one example, the CU-CP may be integrated as a network function (NF) in the SBA core network.

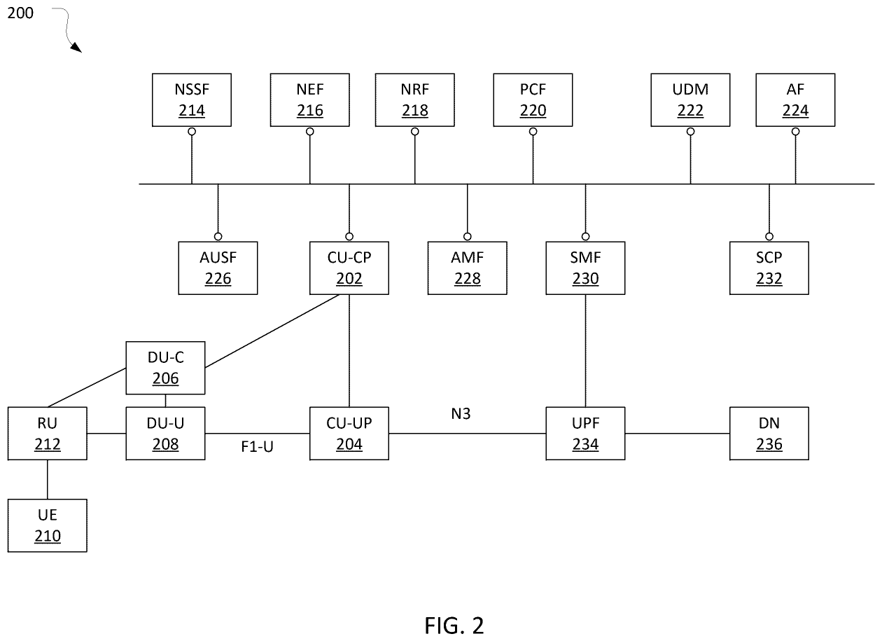

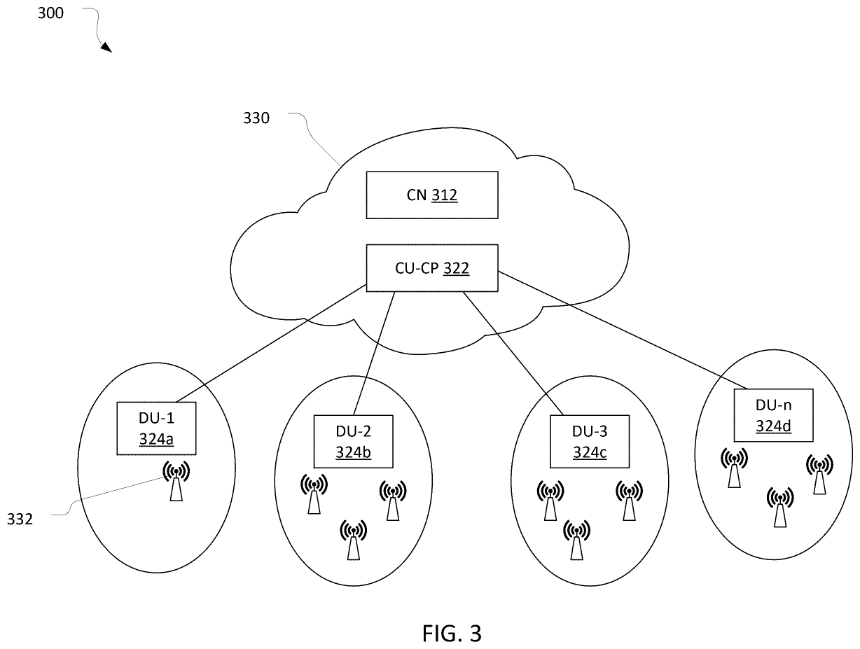

FIG. 2 illustrates an example SBA architecture 200 in accordance with various embodiments. As shown, the SBA architecture 200 may include a CU-CP 202, a CU-UP 204, a DU-C 206, and a DU-U 208. The CU-CP 202 may be connected to multiple DUs (e.g., as illustrated in FIG. 3). In some embodiments, a UE 210 (which may correspond to UE 104) may communicate with other components of the SBA architecture 200, such as DU-C 206, DU-U 208, CU-CP 202, and/or CU-UP 204, via a radio unit 212.

As shown, the CU-CP 202 may be implemented in a core network of the SBA architecture 200. Other components of the core network may include a network slice selection function (NSSF) 214, a network exposure function (NEF) 216, a network repository function (NRF) 218, a policy control function (PCF) 220, a unified data management (UDM) 222, an application function (AF) 224, an authentication server function (AUSF) 226, an access and mobility management function (AMF) 228, a session management function (SMF) 230, and/or a service communication proxy (SCP) 232.

The SBA architecture 200 may further include a user plane function 234 and/or a data network (DN) 236 in a user plane of the SBA architecture 200.

FIG. 3 illustrates an example network environment 300 in accordance with some embodiments. The network environment 300 includes a CN 312 and a CU-CP 322 deployed in the cloud 330. The CU-CP 322 may be coupled with multiple DUs 324a-d. The individual DUs 324a-d may provide one or more cells 332.

With the CU-CP 322 deployed in the CN, the number of DUs 324a-d coupled to the CU-CP 322 may increase. Accordingly, the CU-CP 322 would be required to support a larger number of UEs. This may cause a heavy processing burden in the CU-CP 322 for RAN-CP control and/or increased access stratum (AS)-CP latency.

Various embodiments herein provide techniques to distribute CP functionality between the CU and the DU. For example, the AS-CP function (e.g., RRC) may be split between the CU and the DU. In some embodiments, the function splitting may be flexibly configurable, such as based on where the CU is deployed (e.g., in the RAN or in the CN).

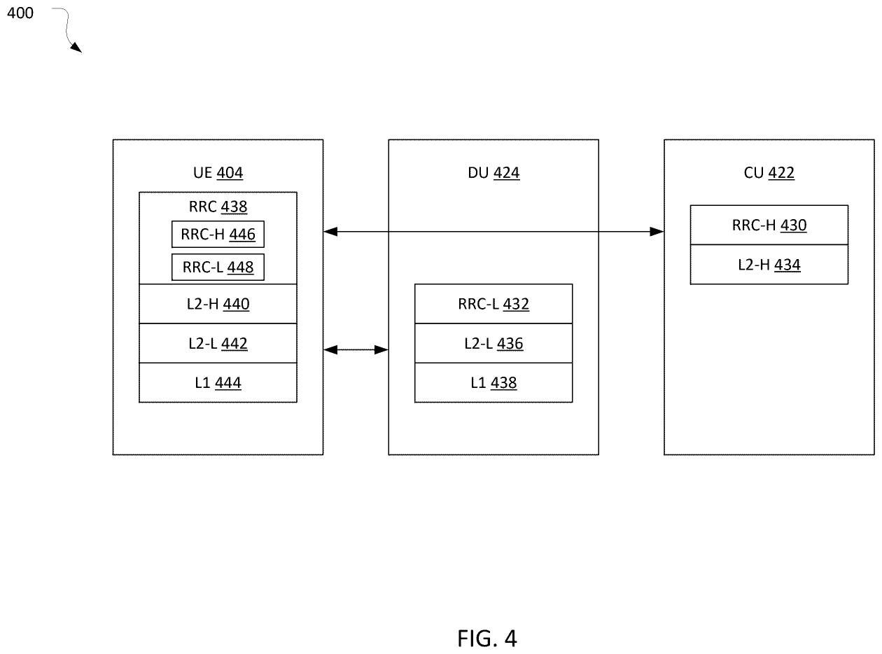

FIG. 4 illustrates example protocol stacks of a UE 404, a CU 422 and a DU 424 in accordance with some embodiments. As shown, the CU 422 may include an RRC-high (H) component 430 (referred to herein as “RRC-H 430”), and the DU 424 may include an RRC-low (L) component 432 (referred to herein as “RRC-L 432”). Individual RRC functions may handled by RRC-H 430, handled by RRC-L 432, and/or split between RRC-H 430 and RRC-L 432.

As shown in FIG. 4, the CU 422 may further include a layer 2 (L2)-H 434. The DU 424 may further include a L2-L 436. The L2-H 434 and L2-L 436 may handle respective L2 functions. For example, The L2-H 434 may handle PDCP and/or SDAP functions, and the L2-L 436 may handle RLC and/or MAC functions. The DU 424 may further include a layer 1 (L1) 438. The L1 438 may be responsible for establishing and maintaining a physical link with the UE 404 via an air interface.

The UE 404 may include RRC layer 438, L2-H 440, L2-L 442, and L1 444. The RRC layer 438 may interface with the RRC-H 430 of the CU 422 and/or the RRC-L 432 of the DU 424. In some embodiments, the RRC layer 438 may include an RRC-H component 446 and an RRC-L component 448 to interface with the RRC-H 430 and RRC-L 432, respectively.

In some embodiments, CP functions may be split between the RRC-H 430 of the CU 422 and RRC-L 432 of the DU 424, located entirely in the RRC-H 430, and/or located entirely in the RRC-L 432. In one example, mobility control may be split between the RRC-H 430 and RRC-L 432, with the RRC-L 432 of the DU 424 handling intra-DU mobility (e.g., handover of the UE 104 to a target cell that is associated with a same DU as the source cell) and the RRC-H 430 of the CU 422 handling inter-DU mobility (e.g., handover of the UE 104 to a target cell that is associated with a different DU from the source cell). The CU 422 and DU 424 may coordinate on functions that are split between them. In another example, PDU session control, RB control, and/or NAS message transmission may be handled entirely by the RRC-H 430 in the CU 422. In another example, access control in the RAN side may be located entirely in the RRC-L 432 in the DU 424.

In various embodiments, the UE 404 may receive separate configurations for RRC-H and RRC-L operations. For example, the RRC-H configuration may be provided by the CU 422, while the RRC-L configuration may be provided by the DU 424. The RRC-H configuration may include configuration information for functions that are controlled and/or used by the CU 422, such as RB level configuration, NAS configuration, CN related information, slicing, quality-of-service (QoS), etc. In some embodiments, RRC-H messages may be carried via the whole L2 protocol stack, e.g., including L2-H 434 and L2-L 436. The RRC-H messages may be encrypted in the L2-PDCP layer based on the RRC key and PDCP sequence number (SN).

The RRC-L configuration may include configuration information for functions that are controlled and/or used in the DU, such as L1 functions, L2-L functions, and/or intra-DU mobility.

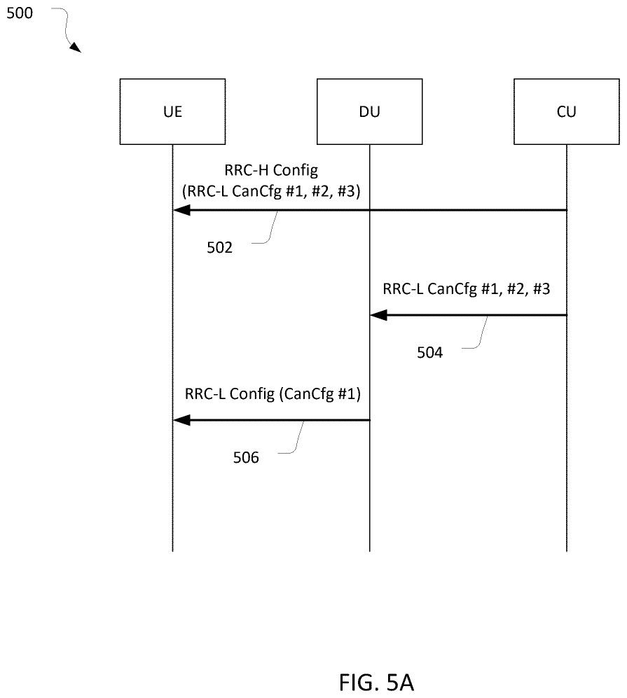

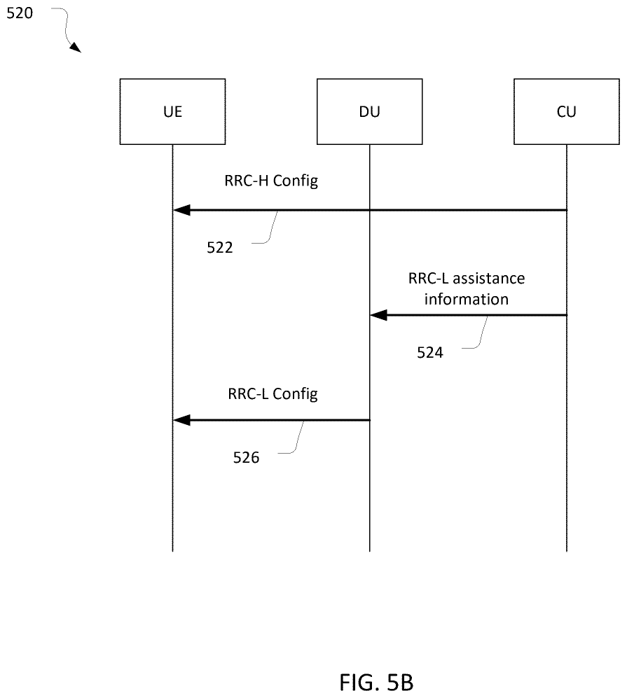

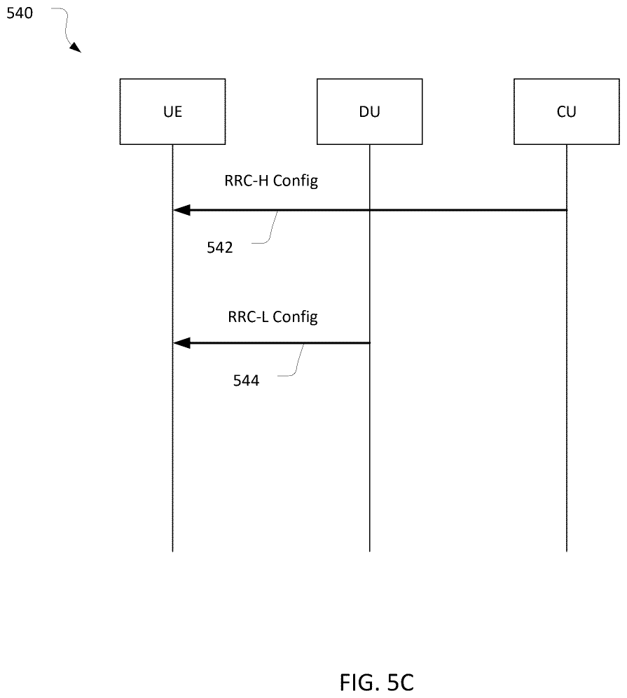

FIGS. 5A, 5B, and 5C illustrate some example procedures for signaling the RRC-L configuration and/or RRC-H configuration to the UE, in accordance with some embodiments. At 502 of the procedure 500 of FIG. 5A, the CU may transmit configuration information to the UE that includes the RRC-H configuration and multiple RRC-L candidate configurations (denoted by “CanCfg” in FIG. 5A). The RRC-L candidate configurations may be associated with respective configuration identifiers (IDs).

At 504, the CU may send the RRC-L candidate configurations to the DU. The DU may select one of the RRC-L candidate configurations to use for the UE (e.g., CanCfg #1 in this example). At 506, the DU may transmit, to the UE, a message to indicate the selected RRC-L candidate configuration for use (e.g., based on the respective configuration ID). Alternatively, the DU may provide the RRC-L candidate configurations to the CU, and the CU may select one of the RRC-L candidate configurations and indicate the selected RRC-L configuration to the UE (e.g., along with the RRC-H configuration at 502).

FIG. 5B illustrates another example procedure 520, in which the DU provides the detailed RRC-L configuration to the UE based on input from the CU. At 522 of the procedure 520, the CU sends the RRC-H configuration to the UE. At 524, the CU provides assistance information to the DU (e.g., via the F1 interface). The DU may determine the RRC-L configuration based on the assistance information. For example, the assistance information may include a set of candidate configurations from which the DU can select the RRC-L configuration. At 526, the DU sends the RRC-L configuration to the UE.

FIG. 5C illustrates another example procedure 540, in which the DU determines the RRC-L configuration without assistance information from the CU and provides the RRC-L configuration to the UE. At 542 of the procedure 540, the CU sends the RRC-H configuration to the UE. At 544 of the procedure 540, the DU sends the RRC-L configuration to the UE.

Embodiments herein further provide techniques for transmission of the RRC-L message to the UE. In some embodiments, the RRC-L message may be carried in the L2-L protocol data unit (PDU). In one example, the RRC-L message may be carried in a MAC control element (CE). In some cases, the RRC-L message may correspond to an ID, such as the RRC-L configuration ID described above, which enables it to be carried in a MAC CE.

In other embodiments, the RRC-L message may be formatted as an RRC message. In one example, the RRC-L message may be an RRC message carried in the L2-L PDU, such as a RLC PDU or a MAC subPDU. In another example, the RRC-L message may be a set of RRC parameters carried in the container of the L2-L PDU. The L2-L PDU may include a designated ID (e.g., logical channel ID (LCID) in the MAC header) to indicate that the L2-L PDU corresponds to the RRC-L message. Security protection of the RRC-L message may be performed in the RRC-L layer and/or in L2-L (e.g., based on RLC SN and/or RRC message ID).

In other embodiments, the RRC-L message may be an RRC message transmitted over the whole L2 protocol stack (including PDCP). This may require the DU to support the full L2 protocol stack. The RRC-L message may be transmitted over PDCP, which enables the PDCP to provide security protection for the message. The RRC-L message my include a designated ID (e.g., signaling radio bearer (SRB) ID and/or LCID) to identify the message as the RRC-L.

In some cases, the RRC-H and/or RRC-L messages may be transmitted and used independently, e.g., without needing the other part of the RRC configuration. For example, an RRC-H message with a NAS message (uplink or downlink) may be used without a corresponding RRC-L message. Additionally, an RRC-L message with a L1 configuration update may not impact the RRC-H configuration and may be used independently.

In other cases, the transmission of RRC-H and RRC-L messages may be coordinated. For example, if the CU generates an RRC-H configuration which requires a corresponding RRC-L configuration, the CU may request the DU to generate the RRC-L configuration. If the DU generates an RRC-L configuration that may impact the RRC-H configuration, the DU may inform the CU (e.g., request the CU to update the RRC-H configuration).

There are several techniques that may be used to indicate an association between an RRC-H message and a corresponding RRC-L message to the UE in accordance with various embodiments. For example, the RRC-H and RRC-L messages may be transmitted in a same time period. In another example, the RRC-H message may be carried in the container of the RRC-L message. In another example, the RRC-H and RRC-L configurations may both include an RRC configuration ID to indicate that they are related to the same full RRC configuration. In another example, the RRC-L message may have a message ID that identifies the corresponding RRC-H message. In another example, the RRC-L message may include one or more parameters from the corresponding RRC-H configuration to indicate the association.

In some embodiments, the UE may identify the associated RRC-H and RRC-L messages and apply the respective configurations together (e.g., to apply a full RRC configuration). The UE may verify that it has the full RRC configuration based on receiving both the RRC-H message and RRC-L message and/or based on the content of the RRC-H and RRC-L configurations.

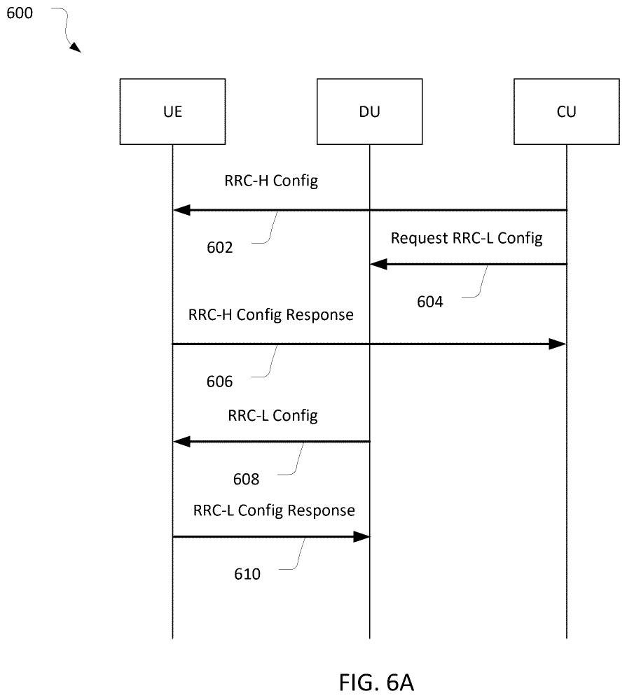

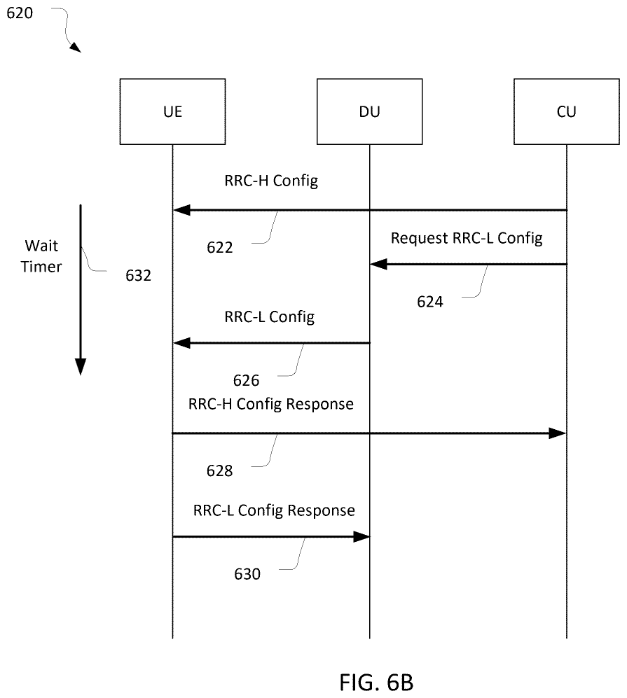

In some embodiments, the UE may send a response to the respective CU and DU on a per message basis (e.g., independently based on receipt of the respective RRC-H message or RRC-L message without waiting for the full RRC configuration). FIG. 6A illustrates an example procedure 600 in accordance with some embodiments. At 602 of the procedure 600, the CU sends the UE an RRC-H message with an RRC-H configuration. At 604 of the procedure 600, the CU may send the DU a request for an RRC-L configuration. At 606 of the procedure 600, the UE may send an RRC-H response to the CU (e.g., to indicate that the RRC-H configuration was successfully received). At 608 of the procedure 600, the DU may send the UE an RRC-L message with an RRC-L configuration. At 610 of the procedure 600, the UE may send an RRC-L response to the DU (e.g., to indicate that the RRC-L configuration was successfully received).

Accordingly, in the procedure 600, the UE may send responses independently based on receipt of the RRC-H message and RRC-L message, respectively. This may require implementation changes on the network side to confirm that the full RRC configuration has been received by the UE. For example, the DU may confirm to the CU that it has received the RRC-L response from the UE. If the UE does not receive the full RRC configuration (e.g., does not receive both the RRC-H message and associated RRC-L message), the UE may ignore or discard the configuration (e.g., without implementing it).

In other embodiments, the UE may send an RRC response based on receipt of both the RRC-H message and the associated RRC-L message. FIG. 6B illustrates an example procedure 620 in accordance with various embodiments. At 622 of the procedure 620, the CU may send the UE an RRC-H message with an RRC-H configuration. At 624 of the procedure 620, the CU may send the DU a request for an RRC-L configuration. At 626 of the procedure 620, the DU may send the UE an RRC-L message with an RRC-L configuration. At 628 of the procedure 620, the UE may send an RRC-H response to the CU that indicates that the UE has successfully received both the RRC-H message and the associated RRC-L message. At 630 of the procedure 620, the UE may send an RRC-L response to the DU to indicate that the UE has successfully received both the RRC-L message and the associated RRC-H message.

In some embodiments, the UE may start a wait timer 632 based on receipt of the RRC-H message at 622. If the UE has not received the associated RRC-L message prior to expiration of the wait timer 632, the UE may discard the received RRC-H message and/or take another action. For example, the UE may trigger an RRC reestablishment procedure. Alternatively, the UE may send a failure response message to the network (e.g., to the DU and/or CU) to indicate that the full RRC configuration was not successfully received, and wait for the network to reconfigure the RRC configuration.

In some embodiments, the UE may receive multiple RRC-L configurations that are associated with the same RRC-H configuration. The UE may receive an indication from the DU to activate one of the RRC-L configurations from among the set of RRC-L configurations. This may enable dynamic switching of the RRC-L configuration without changing the RRC-H configuration.

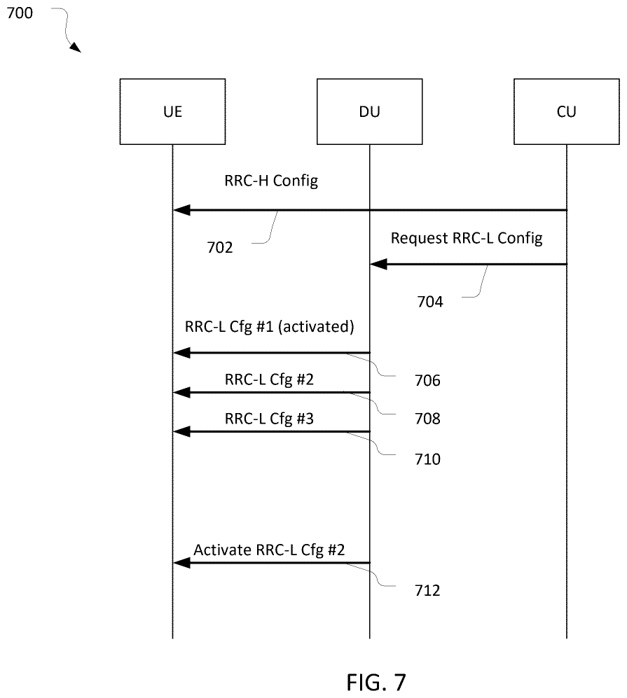

FIG. 7 illustrates an example procedure 700 in accordance with some embodiments. At 702, the CU may send the UE an RRC-H message with an RRC-H configuration. At 704, the CU may send the DU a request for the DU to provide the UE with an RRC-L configuration that is associated with the RRC-H configuration. The DU may send the UE a set of multiple RRC-L configurations that are associated with the RRC-H configuration, e.g., at 706, 708, and 710 of FIG. 7. Although the RRC-L configurations are depicted in FIG. 7 as separate transmissions, multiple RRC-L configurations may be included in the same transmission in some embodiments. The DU may initially identify the first RRC-L configuration (RRC-L Cfg #1) as active. At 712 of the procedure 700 (e.g., after the RRC-L configurations are provided to the UE), the DU may send an activation message to the UE to indicate that the second RRC-L configuration (RRC-L Cfg #2) is activated from among the previously configured set. In some embodiments, the DU may use L1 and/or L2 signaling for the activation message (e.g., a DCI and/or MAC CE). Accordingly, the procedure 700 may enable dynamic switching of the RRC-L configuration without changing or needing to retransmit the associated RRC-H configuration.

In various embodiments, the RRC-L configuration provided by the DU may be associated with a QoS requirement. Embodiments herein provide techniques to enable dynamic switching between different QoS requirements. For example, the DU may configure multiple RRC-L configurations with respective QoS requirements. Additionally, or alternatively, an individual RRC-L configuration may have multiple candidate RLC and/or logical channel (LCH) configurations, which may then be dynamically activated. The decision to activate a different QoS configuration may be made by the DU and/or by the UE. In some embodiments, when a new QoS configuration is activated, the UE may update the QoS configuration without establishing a new RLC entity.

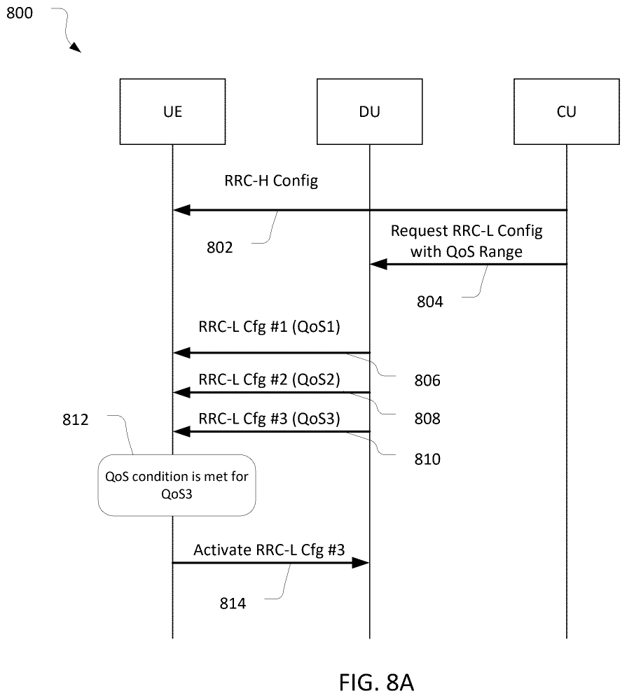

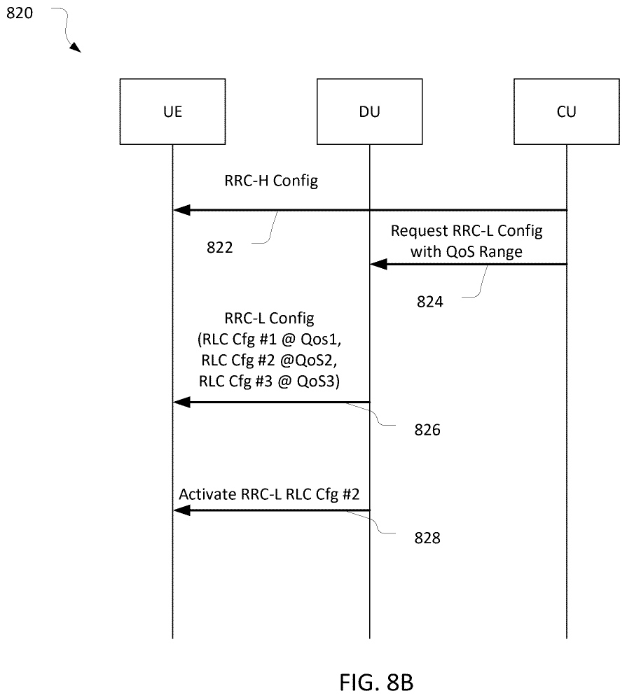

FIG. 8A illustrates an example procedure 800 in accordance with some embodiments. At 802, the CU may send an RRC-H configuration to the UE. The RRC-H configuration may include, for example, a SDAP configuration and/or a PDCP configuration. At 804, the CU may send a request to the DU for an RRC-L configuration with a QoS range.

The DU may send the UE multiple RRC-L configurations (illustrated at 806, 808, and 810 of FIG. 8A) that include respective QoS requirements. In some embodiments, the QoS requirements may be associated with respective conditions. At 812, the UE may determine that a condition for one of the QoS requirements has been met (e.g., QoS3 in this example). At 814, the UE may send a message to the DU to activate the RRC-L configuration associated with that QoS requirement (e.g., RRC-L Cfg #3 in this example).

FIG. 8B illustrates another example procedure 820 in accordance with some embodiments. At 822, the CU may send an RRC-H configuration to the UE. The RRC-H configuration may include, for example, a SDAP configuration and/or a PDCP configuration. At 824, the CU may send a request to the DU for an RRC-L configuration with a QoS range.

At 826 of the procedure 800, the DU may send the UE an RRC-L configuration that includes multiple RLC and/or LCH configurations with respective QoS levels. One of the RLC configurations may initially be active, e.g., RLC Cfg #1. The DU may later send an activation message at 828 of the procedure 820 to activate a different RLC configuration (e.g., RLC Cfg #2).

In 5G systems, the DU, CU, and AMF perform operations to jointly provide access control for the RAN. However, if the CU is located on the CN side, the load on the CU-CP for access control may increase. Additionally, two level access control may increase latency.

In various embodiments herein, the DU may handle access control for the RAN. For initial access (e.g., RRC setup, reestablishment, and/or resume), the DU may decode the cause indicated in the initial access message from a UE and perform access control (e.g., to determine whether the UE will be granted access to the RAN). In some embodiments, the DU may receive an access control policy from the CU, and perform the access control for the RAN based on the access control policy.

In case of access control success (e.g., UE is granted access), the DU may send a message to the CU to indicate the success. The CU may perform one or more further operations, such as a security mode command (SMC) procedure and/or RRC reconfiguration (e.g., including transmission of the RRC-H configuration described herein). In case of access control failure (e.g., due to network congestion and/or another issue), the DU may send a message to the UE to indicate the failure.

In some embodiments, the DU may handle access control via RRC signaling. In other embodiments, the DU may handle access control via the random access channel (RACH)/L2 procedure.

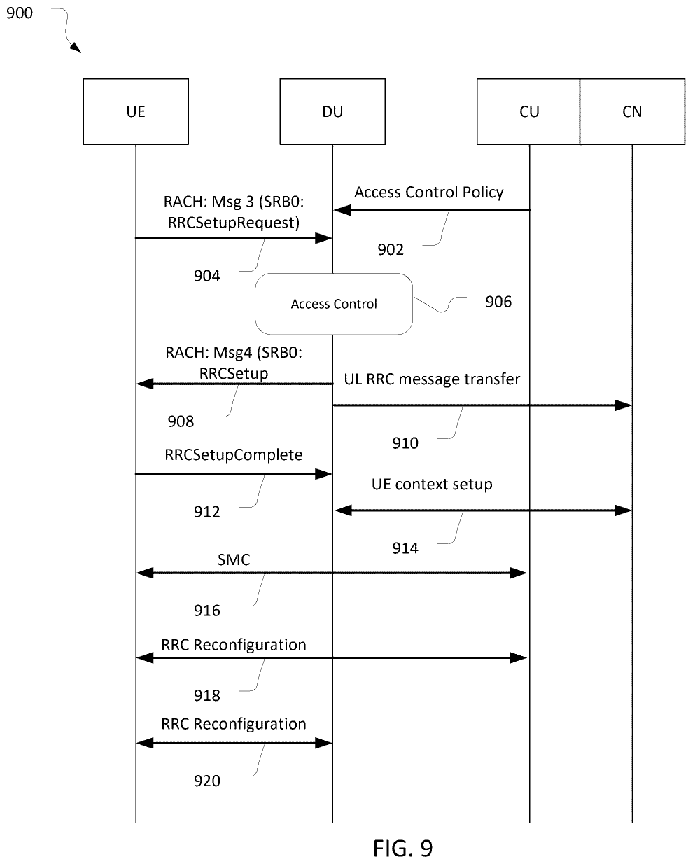

FIG. 9 illustrates an example procedure 900 in accordance with various embodiments. In the procedure 900, the DU may handle access control via RRC signaling.

At 902 of the procedure 900, the DU may receive an access control policy from the CU.

At 904 of the procedure 900, the DU may receive an RRC setup request message (e.g., RRCSetupRequest) to request an RRC connection with a RAN associated with the DU. In some embodiments, the RRC setup request message may be included in a Msg3 of a RACH procedure. At 906 of the procedure 900, the DU may perform access control. For example, the DU may determine whether to grant access to the UE based on the RRC setup request and/or the access control policy.

If the access control is successful (UE will be granted access), the DU transmits, at 908 of the procedure 900, an RRC setup message to the UE. The RRC setup message may be included in a Msg4 of the RACH procedure.

At 910 of the procedure 900, the DU may send a message to the CN with RRC information associated with the UE (e.g., UL RRC message transfer).

At 912 of the procedure 900, the UE may send an RRC setup complete message to the DU, e.g., on a dedicated control channel (DCCH).

At 914 of the procedure 900, the DU may perform UE context setup with the CN.

At 916 of the procedure 900, the CU may perform a SMC procedure with the UE. At 918 of the procedure 900, the UE may perform RRC reconfiguration with the CU. For example, the CU may send the RRC-H configuration to the UE. At 920 of the procedure 900, the UE may perform RRC reconfiguration with the DU. For example, the DU may send the RRC-L configuration to the UE.

If the access control at 906 is unsuccessful (UE will not be granted access), then the DU may transmit a reject message (e.g., in Msg4 of the RACH procedure). The UE may start a wait timer based on the reject message, and may retry the establishment of the RRC connection (e.g., send another RRC setup request message) after expiration of the wait timer.

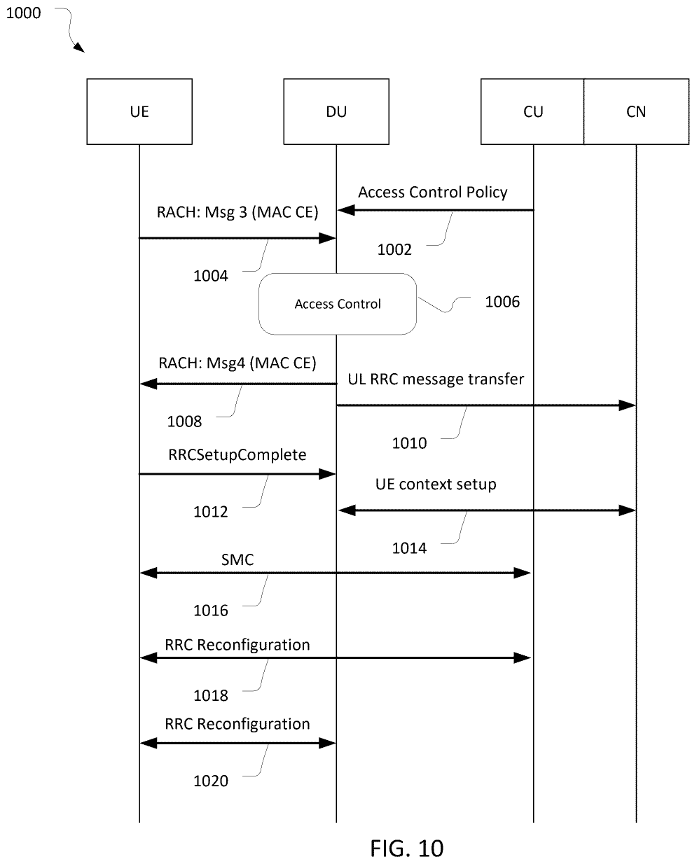

FIG. 10 illustrates another example procedure 1000 in accordance with various embodiments. In the procedure 1000, the DU handles access control via the RACH/L2 procedure (e.g., with MAC signaling).

At 1002 of the procedure 1000, the DU may receive an access control policy from the CU.

At 1004 of the procedure 1000, the DU may receive a MAC CE from the UE to request access to the RAN. In some embodiments, the MAC CE may be included in a Msg3 of a RACH procedure. The MAC CE may include, for example, a UE ID and a cause. At 1006 of the procedure 1000, the DU may perform access control. For example, the DU may determine whether to grant access to the UE based on the MAC CE and/or the access control policy.

If the access control is successful (UE will be granted access), the DU transmits, at 1008 of the procedure 1000, a MAC CE to the UE to indicate that the access control is successful. The MAC CE may be included in a Msg4 of the RACH procedure.

At 1010 of the procedure 1000, the DU may send a message to the CN with RRC information associated with the UE (e.g., UL RRC message transfer).

At 1012 of the procedure 1000, the UE may send an RRC setup complete message to the DU, e.g., on the DCCH.

At 1014 of the procedure 1000, the DU may perform UE context setup with the CN.

At 1016 of the procedure 1000, the CU may perform a SMC procedure with the UE.

At 1018 of the procedure 1000, the UE may perform RRC reconfiguration with the CU. For example, the CU may send the RRC-H configuration to the UE. At 1020 of the procedure 1000, the UE may perform RRC reconfiguration with the DU. For example, the DU may send the RRC-L configuration to the UE.

If the access control at 1006 is unsuccessful (UE will not be granted access), then the DU may transmit a MAC CE to the UE to indicate that the access request is rejected. The UE may start a wait timer based on the rejection, and may retry the establishment of the RRC connection (e.g., send another MAC CE at 1004 of the procedure 1000) after expiration of the wait timer.

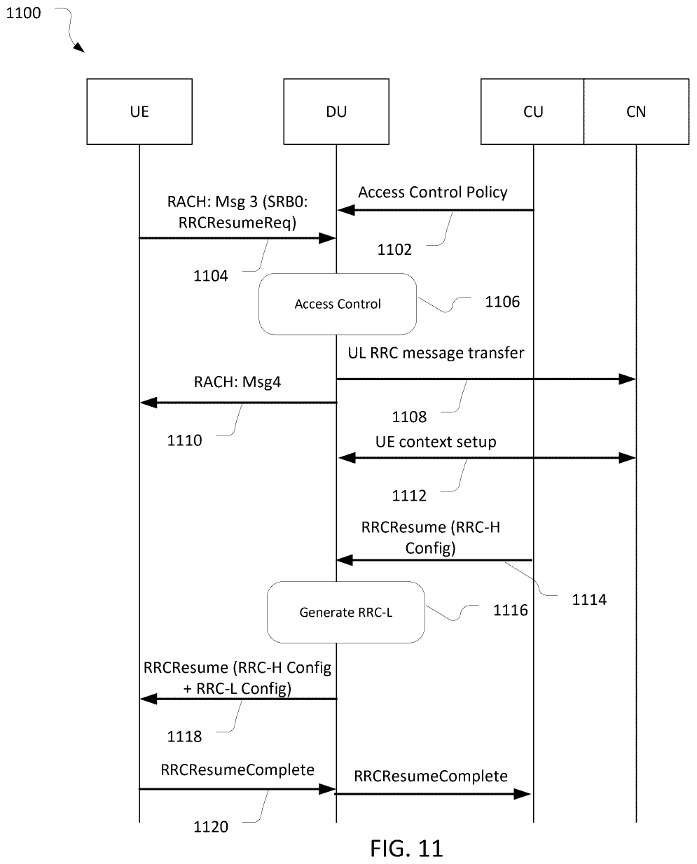

FIG. 11 illustrates another example procedure 1100 in accordance with various embodiments. In the procedure 1100, the DU performs access control as part of the RRC resume procedure.

At 1102 of the procedure 1100, the DU may receive an access control policy from the CU.

At 1104 of the procedure 1100, the DU may receive an RRC resume request message (e.g., RRCResumeRequest) to request resumption of an RRC connection with a RAN associated with the DU. In some embodiments, the RRC resume request message may be included in a Msg3 of a RACH procedure. At 1106 of the procedure 1100, the DU may perform access control. For example, the DU may determine whether to resume the RRC connection with the UE based on the RRC resume request and/or the access control policy.

If the access control is successful (UE will be granted access), the DU transmits, at 1108 of the procedure 1100, a message to the CN with RRC information associated with the UE (e.g., UL RRC message transfer). At 1110 of the procedure 1100, the DU transmits a Msg4 to the UE to indicate that the RRC connection will be resumed.

At 1112 of the procedure 1100, the DU and the CN may perform UE context setup.

At 1114 of the procedure 1100, the DU may receive an RRC resume message from the CU. The RRC resume message may include the RRC-H configuration. At 1116 of the procedure 1100, the DU may generate the RRC-L configuration.

At 1118 of the procedure 1100, the DU may transmit an RRC resume message to the UE. The RRC resume message may include the RRC-H configuration and the RRC-L configuration. At 1120 of the procedure 1100, the UE may send an RRC resume complete message to the DU and/or the CU.

If the access control at 1106 is unsuccessful (UE will not be granted access), then the DU may transmit a reject message (e.g., in Msg4 of the RACH procedure). The UE may start a wait timer based on the reject message, and may retry the establishment of the RRC connection after expiration of the wait timer.

Various embodiments herein further provide techniques related to mobility and measurement. In 5G, for L3 mobility such as handover, conditional handover, and SDAP, the measurement and mobility are controlled by RRC in the CU-CP. For L1/L2 triggered mobility (LTM), RRM measurements and associated candidate set are controlled by RRC in the CU-CP. Since all configurations are provided by the CU via RRC in advance, the configuration overhead is large. Additionally, changing the candidate configuration introduces latency and extra signaling overhead in the F1 and Uu interfaces. Furthermore, the mobility decision depends on the CU (e.g., based on RRM measurement results in L3), which leads to extra mobility delay.

In some embodiments, the DU may handle one or more mobility aspects. For example, the DU may handle intra-DU mobility (e.g. when the UE is handed over to a target cell associated with the same DU as the source cell), while the CU may handle inter-DU mobility (e.g., when the target cell is associated with a different DU than the source cell, including inter-CU mobility in which the CU also changes). In some embodiments, the DU may include a mobility-related measurement function to support measurements in L1 and/or L2.

The RRC-L configuration provided by the DU may include an intra-CU mobility configuration for intra-DU mobility. The RRC-L message that includes the intra-CU mobility configuration may trigger a mobility procedure (e.g., including measurements on candidate cells and reporting the measurement results to the network). The intra-CU mobility configuration may include a measurement configuration, e.g., indicating a candidate set of cells on which the UE is to perform measurements. In other embodiments, the DU may provide multiple RRC-L configurations to the UE with respective intra-CU mobility configurations (e.g., respective candidate sets). The DU may transmit a L1 DCI with an indication of one of the RRC-L configurations to the UE to trigger the mobility procedure for the candidate set of the indicated RRC-L configuration. The UE may report the measurement results via an RRC-L message.

The RRC-H configuration provided by the CU may include an inter-DU mobility configuration for inter-DU mobility. The UE may perform inter-DU measurements based on the inter-DU mobility configuration. In some embodiments, the UE may report the measurement results to the CU via an RRC-H message. In other embodiments, the UE may provide the inter-DU measurement results and intra-DU measurement results to the DU via one or more RRC-L messages. The DU may forward the inter-DU measurement results to the CU.

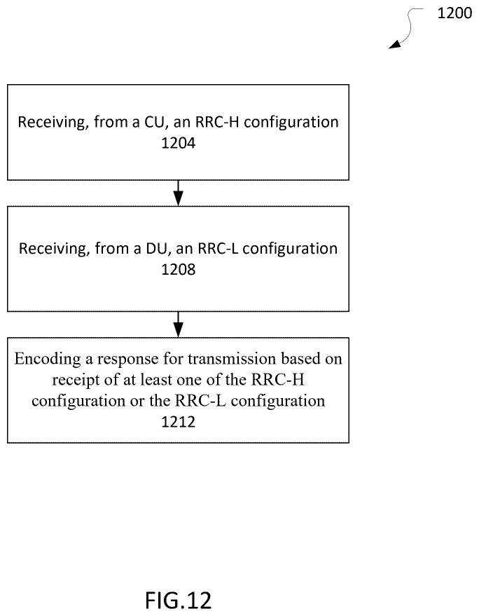

FIG. 12 is an operational flow/algorithmic structure 1200 that for split RRC-H and RRC-L configuration in accordance with some embodiments. The operational flow/algorithmic structure 1200 may be implemented by a UE such as, for example, UE 104, UE 1400, or components thereof; for example, a baseband processor 1404A.

The operation flow/algorithmic structure 1200 may include, at 1204, receiving, from a CU, an RRC-H configuration. In some embodiments, the RRC-H configuration may include configuration information associated with one or more functions that are controlled by the CN, such as SDAP, PDCP, RB control, NAS signaling, and/or inter-DU mobility.

The operational flow/algorithmic structure 1200 may further include, at 1208, receiving, from a DU, an RRC-L configuration. The RRC-L configuration may include configuration information for one or more functions that are controlled by the DU, such as L1 (PHY), RLC, MAC, and/or intra-DU mobility.

The operational flow/algorithmic structure 1200 may further include, at 1212, encoding a response for transmission based on receipt of at least one of the RRC-H configuration or the RRC-L configuration. In some embodiments, the UE may transmit the response based on receipt of both the RRC-H configuration and the RRC-L configuration. Alternatively, the UE may transmit respective responses based on receipt of the RRC-H configuration and the RRC-L configuration independently.

In some embodiments, the RRC-H and RRC-L configuration may be associated with one another. For example, to indicate the association: the RRC-H configuration and the RRC-L configuration may transmitted in a same time period; the RRC-H configuration may be included in an RRC-L message that also includes the RRC-L configuration; the RRC-H configuration and the RRC-L configuration may include a same RRC configuration ID; the RRC-L configuration includes an RRC-H ID of the RRC-H configuration; and/or the RRC-L configuration includes one or more parameters of the RRC-H configuration.

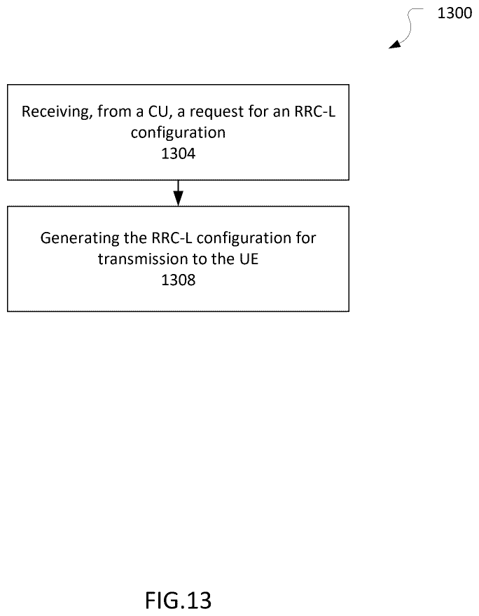

FIG. 13 is another operational flow/algorithmic structure 1300 in accordance with some embodiments. The operational flow/algorithmic structure 1300 may be performed by a DU such as DU 124, network device 1500, or components thereof, for example, processors 1504A.

The operational flow/algorithmic structure 1300 may include, at 1304, receiving, from a CU, a request to provide an RRC-L configuration to a UE.

The operational flow/algorithmic structure 1300 may further include, at 1308, generating the RRC-L configuration for transmission to the UE. In embodiments, the RRC-L configuration may include configuration information related to a L1, a L2-L, and/or intra-DU mobility.

In some embodiments, the RRC-L configuration may be associated with an RRC-H configuration that is provided by the CU to the UE. In some embodiments, to indicate the association between the RRC-L configuration and the RRC-H configuration: the RRC-L configuration may be transmitted in a same time period as the RRC-H configuration; the RRC-L configuration may be transmitted in an RRC-L message that also includes the RRC-H configuration; the RRC-L configuration may include an RRC configuration ID that is also included in the RRC-H configuration; the RRC-L configuration may include an RRC-H ID of the RRC-H configuration; and/or the RRC-L configuration may include one or more parameters of the RRC-H configuration.

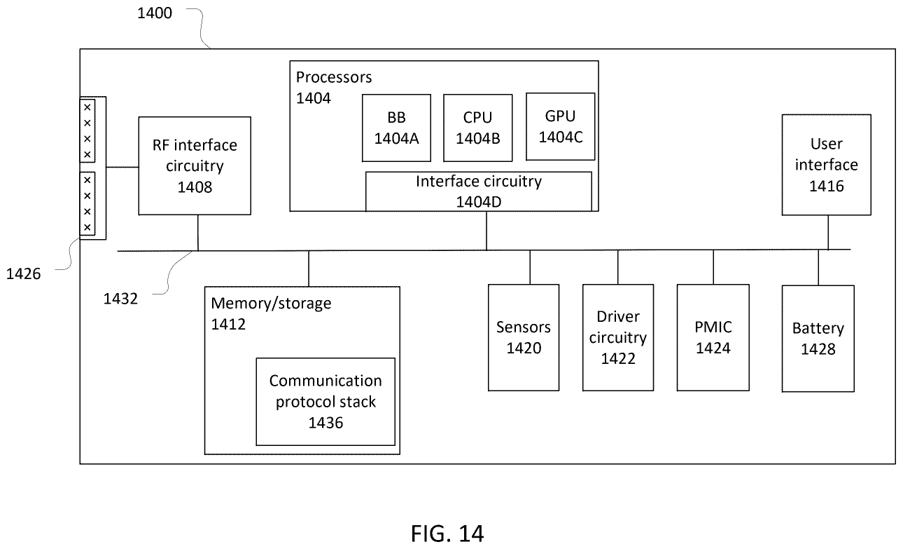

FIG. 14 illustrates a UE 1400 in accordance with some embodiments. The UE 1400 may be similar to and substantially interchangeable with UE 104.

The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein (e.g., operations associated with an RRC functional split between a CU and a DU). The processors 1404 may also include interface circuitry 1404D to enable communication by, for example, communicatively coupling the processor circuitry with one or more other components of the UE 1400.

In some embodiments, the baseband processor 1404A may access a communication protocol stack 1436 in the memory/storage 1412 to communicate over a 3GPP compatible network. In general, the baseband processor 1404A may access the communication protocol stack 1436 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform operations as described herein (e.g., operations associated with an RRC functional split between a CU and a DU).

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

A battery 1428 may power the UE 1400, although in some examples the UE 1400 may be mounted deployed in a fixed location and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

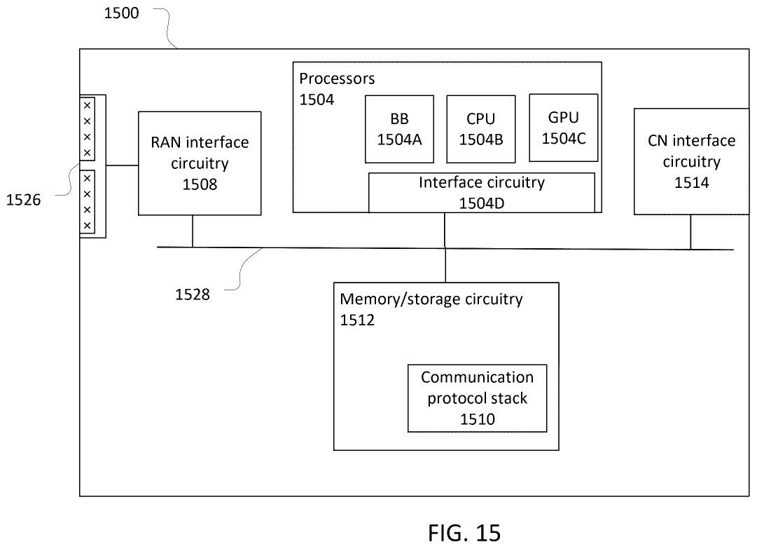

FIG. 15 illustrates a network device 1500 in accordance with some embodiments. The network device 1500 may be similar to, and substantially interchangeable with, the base station 108, the CU 122, the DU 124, and/or a component of the CN 112.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the network device 1500 to perform operations as described herein (e.g., operations associated with an RRC functional split between a CU and a DU). The processors 1504 may also include interface circuitry 1504D to communicatively couple the processor circuitry with one or more other components of the network device 1500.

The CN interface circuitry 1514 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

Example 1 may include a method comprising: receiving a radio resource control (RRC)-high (H) configuration associated with a centralized unit (CU); receiving an RRC-low (L) configuration associated with a distributed unit (DU); and encoding a response for transmission based on receipt of at least one of the RRC-H configuration or the RRC-L configuration.

Example 2 may include the method of example 1 or some other example herein, wherein the RRC-L configuration is a first RRC-L configuration, and wherein the method further comprises: receiving, from the DU, a set of RRC-L configurations, including the first RRC-L configuration; and receiving, from the DU, a message to activate the first RRC-L configuration from among the set of RRC-L configurations.

Example 3 may include the method of example 2 or some other example herein, wherein the set of RRC-L configurations is associated with the RRC-H configuration.

Example 4 may include the method of example 2 or some other example herein, wherein the set of RRC-L configurations includes respective quality-of-service (QoS) requirements.

Example 5 may include the method of example 1 or some other example herein, further comprising: identifying that the RRC-L configuration is associated with the RRC-H configuration; and implementing the RRC-L configuration and the RRC-H configuration based on the receipt of both of the RRC-L configuration and the RRC-H configuration.

Example 6 may include the method of example 5 or some other example herein, wherein the response is transmitted based on the receipt of both of the RRC-L configuration and the RRC-H configuration.

Example 7 may include the method of example 5 or some other example herein, wherein, to indicate the association between the RRC-L configuration and the RRC-H configuration: the RRC-H configuration and the RRC-L configuration are transmitted in a same time period; the RRC-H configuration is included in an RRC-L message that also includes the RRC-L configuration; the RRC-H configuration and the RRC-L configuration include a same RRC configuration identifier (ID); the RRC-L configuration includes an RRC-H ID of the RRC-H configuration; or the RRC-L configuration includes one or more parameters of the RRC-H configuration.

Example 8 may include the method of example 1 or some other example herein, wherein the RRC-L configuration includes configuration information related to a layer 1 (L1) or a layer 2 (L2)-L.

Example 9 may include the method of example 1 or some other example herein, wherein the RRC-H configuration includes protocol data unit (PDU) session and radio bearer configuration information applicable for a first layer 2 (L2) protocol stack deployed in the CU, and the RRC-L configuration includes radio bearer configuration information applicable for a second L2 protocol stack deployed in the DU.

Example 10 may include the method of example 1 or some other example herein, wherein the RRC-L configuration includes multiple sub-configurations for a radio link control (RLC) or a logical channel (LCH) with respective quality-of-service (QoS) requirements, and wherein the method further comprises receiving a message from the DU to activate a first sub-configuration from among the multiple sub-configurations.

Example 11 may include the method of example 1 or some other example herein, further comprising: encoding an RRC message or a medium access control (MAC) control element (CE) for transmission to the DU to request access to a network; and receiving, from the DU, a response to the request.

Example 12 may include the method of example 1 or some other example herein, wherein the RRC-H configuration includes an inter-DU mobility configuration and the RRC-L configuration includes an intra-DU mobility configuration.

Example 13 may include the method of example 12 or some other example herein, further comprising: obtaining intra-DU measurements based on the intra-DU mobility configuration; and reporting the intra-DU measurements to the DU via an RRC-L message.

Example 14 may include the method of example 13 or some other example herein, further comprising: obtaining inter-DU measurements based on the inter-DU mobility configuration; and reporting the inter-DU measurements in an RRC-H message to the CU or in the RRC-L message.

Example 15 may include the method comprising: receiving, from a centralized unit (CU), a request to provide a radio resource control (RRC)-low (L) configuration to a user equipment (UE); and generating the RRC-L configuration for transmission to the UE, wherein the RRC-L configuration includes configuration information related to a layer 1 (L1), a layer 2 (L2)-L, or intra-distributed unit (DU) mobility.

Example 16 may include the method of example 15 or some other example herein, wherein the RRC-L configuration is associated with an RRC-high (H) configuration provided by the CU to the UE.

Example 17 may include the method of example 16 or some other example herein, wherein, to indicate the association between the RRC-L configuration and the RRC-H configuration: the RRC-L configuration is transmitted in a same time period as the RRC-H configuration; the RRC-L configuration is transmitted in an RRC-L message that also includes the RRC-H configuration; the RRC-L configuration includes an RRC configuration identifier (ID) that is also included in the RRC-H configuration; the RRC-L configuration includes an RRC-H ID of the RRC-H configuration; or the RRC-L configuration includes one or more parameters of the RRC-H configuration.

Example 18 may include the method of example 15 or some other example herein, wherein the RRC-L configuration is a first RRC-L configuration, and wherein the method further comprises: generating, for transmission to the UE, a set of RRC-L configurations that includes the first RRC-L configuration; and generating, for transmission to the UE, a message to activate the first RRC-L configuration from among the set of RRC-L configurations.

Example 19 may include the method of example 18 or some other example herein, wherein the set of RRC-L configurations is associated with a same RRC-high (H) configuration.

Example 20 may include the method of example 18 or some other example herein, wherein the RRC-L configurations include respective quality-of-service (QoS) requirements.

Example 21 may include the method of example 15 or some other example herein, wherein the RRC-L configuration includes multiple sub-configurations with respective quality-of-service (QoS) requirements, and wherein the method further comprises encoding a message, for transmission to the UE, to activate a first sub-configuration from among the multiple sub-configurations.

Example 22 may include the method of example 15 or some other example herein, further comprising receiving assistance information from the CU, wherein the RRC-L configuration is generated based on the assistance information.

Example 23 may include the method of example 15 or some other example herein, further comprising: receiving a request message from the UE to request access to a network; performing access control to determine whether the UE is allowed to access the network; and generating a response for transmission to the UE based on the determination.

Example 24 may include the method of example 23 or some other example herein, wherein the request message and the response are transmitted via RRC signaling.

Example 25 may include the method of example 23 or some other example herein, wherein the request message and the response are medium access control (MAC) control elements (CEs).

Example 26 may include the method of example 23 or some other example herein, wherein, if it is determined that the UE is allowed to access the network, the method further comprises performing UE context setup for the UE with a core network.

Example 27 may include the method of example 15 or some other example herein, wherein the RRC-L configuration includes the configuration information related to intra-DU mobility, and wherein the method further comprises: receiving intra-DU measurement results from the UE based on the configuration information related to intra-DU mobility; determining to perform a handover of the UE to a target cell based on the intra-DU measurement results; and generating a message for transmission to the UE to trigger the handover.

Example 28 may include a baseband processor comprising: a memory to store a full radio resource control (RRC) configuration; and processor circuitry coupled to the memory, the processor circuitry to: receive an RRC-high (H) configuration from a centralized unit (CU); receive an RRC-low (L) configuration which is generated by a distributed unit (DU), wherein the RRC-L configuration is associated with the RRC-H configuration; and update the full RRC configuration stored in the memory based on the receipt of both the RRC-H configuration and the RRC-L configuration.

Example 29 may include the baseband processor of example 28 or some other example herein, wherein the RRC-L configuration is a first RRC-L configuration, and wherein the processor circuitry is further to: receive, from the DU, a set of RRC-L configurations, including the first RRC-L configuration; and receive, from the DU, a message to activate the first RRC-L configuration from among the set of RRC-L configurations.

Example 30 may include the baseband processor of example 29 or some other example herein, wherein the RRC-L configurations include respective quality-of-service (QoS) requirements.

Example 31 may include the baseband processor of example 28 or some other example herein, wherein the processor circuitry is further to generate a response for transmission to indicate that both the RRC-L configuration and the RRC-H configuration have been received.

Example 32 may include the baseband processor of example 28 or some other example herein, wherein, to indicate the association between the RRC-L configuration and the RRC-H configuration: the RRC-H configuration and the RRC-L configuration are transmitted in a same time period; the RRC-H configuration is included in an RRC-L message that also includes the RRC-L configuration; the RRC-H configuration and the RRC-L configuration include a same RRC configuration identifier (ID); the RRC-L configuration includes an RRC-H ID of the RRC-H configuration; or the RRC-L configuration includes one or more parameters of the RRC-H configuration.

Example 33 may include the baseband processor of example 28 or some other example herein, wherein the RRC-L configuration includes configuration information related to a layer 1 (L1) or a layer 2 (L2)-L.

Example 34 may include the baseband processor of example 28 or some other example herein, wherein the RRC-H configuration includes radio bearer configuration information for a first layer 2 (L2) protocol stack deployed in the CU, and the RRC-L configuration includes radio bearer configuration information for a second L2 protocol stack deployed in the DU.

Example 35 may include the baseband processor of example 28 or some other example herein, wherein the RRC-L configuration includes multiple sub-configurations with respective quality-of-service (QoS) requirements, and wherein the processor circuitry is further to receive a message from the DU to activate a first sub-configuration from among the multiple sub-configurations.

Example 36 may include the baseband processor of example 28 or some other example herein, wherein the processor circuitry is further to: encode an RRC message or a layer 2 (L2) control protocol data unit (PDU) for transmission to the DU to request access to a network; and receive, from the DU, a response to the request.

Example 37 may include the baseband processor of example 28 or some other example herein, wherein the RRC-H configuration includes an inter-DU mobility configuration and the RRC-L configuration includes an intra-DU mobility configuration.

Example 38 may include the baseband processor of example 37 or some other example herein, wherein the processor circuitry is further to: obtain intra-DU measurements based on the intra-DU mobility configuration; and encode an RRC-L message for transmission to the DU, wherein the RRC-L message indicates the intra-DU measurements.

Example 39 may include the baseband processor of example 38 or some other example herein, wherein the processor circuitry is further to: obtain inter-DU measurements based on the inter-DU mobility configuration; and report the inter-DU measurements in an RRC-H message to the CU or in the RRC-L message.

Another example may include an apparatus comprising means to perform one or more elements of a method described in or related to any of examples 1-39, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-39, or any other method or process described herein.

Another example may include an apparatus comprising logic, modules, or circuitry to perform one or more elements of a method described in or related to any of examples 1-39, or any other method or process described herein.

Another example may include a method, technique, or process as described in or related to any of examples 1-39, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-39, or portions thereof.

Another example may include a signal as described in or related to any of examples 1-39, or portions or parts thereof.

Another example may include a datagram, information element, packet, frame, segment, PDU, or message as described in or related to any of examples 1-39, or portions or parts thereof, or otherwise described in the present disclosure.

Another example may include a signal encoded with data as described in or related to any of examples 1-39, or portions or parts thereof, or otherwise described in the present disclosure.

Another example may include a signal encoded with a datagram, IE, packet, frame, segment, PDU, or message as described in or related to any of examples 1-39, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-39, or portions thereof.

Another example may include a computer program comprising instructions, wherein execution of the program by a processing element is to cause the processing element to carry out the method, techniques, or process as described in or related to any of examples 1-39, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving a radio resource control (RRC)-high (H) configuration associated with a centralized unit (CU);
receiving an RRC-low (L) configuration associated with a distributed unit (DU); and
encoding a response for transmission based on receipt of at least one of the RRC-H configuration or the RRC-L configuration.

2. The method of claim 1, wherein the RRC-L configuration is a first RRC-L configuration, and wherein the method further comprises:
receiving, from the DU, a set of RRC-L configurations, including the first RRC-L configuration that are associated with the RRC-H configuration; and
receiving, from the DU, a message to activate the first RRC-L configuration from among the set of RRC-L configurations.

3. The method of claim 1, further comprising:
identifying that the RRC-L configuration is associated with the RRC-H configuration; and
implementing the RRC-L configuration and the RRC-H configuration based on the receipt of both of the RRC-L configuration and the RRC-H configuration.

4. The method of claim 3, wherein the response is transmitted based on the receipt of both of the RRC-L configuration and the RRC-H configuration.

5. The method of claim 3, wherein, to indicate the association between the RRC-L configuration and the RRC-H configuration:
the RRC-H configuration and the RRC-L configuration are transmitted in a same time period;
the RRC-H configuration is included in an RRC-L message that also includes the RRC-L configuration;
the RRC-H configuration and the RRC-L configuration include a same RRC configuration identifier (ID);
the RRC-L configuration includes an RRC-H ID of the RRC-H configuration; or
the RRC-L configuration includes one or more parameters of the RRC-H configuration.

6. The method of claim 1, wherein the RRC-L configuration includes configuration information related to a layer 1 (L1) or a layer 2 (L2)-L.

7. The method of claim 1, wherein the RRC-H configuration includes protocol data unit (PDU) session and radio bearer configuration information applicable for a first layer 2 (L2) protocol stack deployed in the CU, and the RRC-L configuration includes radio bearer configuration information applicable for a second L2 protocol stack deployed in the DU.

8. The method of claim 1, wherein the RRC-L configuration includes multiple sub-configurations for a radio link control (RLC) or a logical channel (LCH) with respective quality-of-service (QoS) requirements, and wherein the method further comprises receiving a message from the DU to activate a first sub-configuration from among the multiple sub-configurations.

9. The method of claim 1, further comprising:
encoding an RRC message or a medium access control (MAC) control element (CE) for transmission to the DU to request access to a network; and
receiving, from the DU, a response to the request.

10. The method of claim 1, wherein the RRC-H configuration includes an inter-DU mobility configuration and the RRC-L configuration includes an intra-DU mobility configuration.

11. The method of claim 10, further comprising:
obtaining intra-DU measurements based on the intra-DU mobility configuration; and
reporting the intra-DU measurements to the DU via an RRC-L message.

12. A method comprising:
receiving, from a centralized unit (CU), a request to provide a radio resource control (RRC)-low (L) configuration to a user equipment (UE); and
generating the RRC-L configuration for transmission to the UE, wherein the RRC-L configuration includes configuration information related to a layer 1 (L1), a layer 2 (L2)-L, or intra-distributed unit (DU) mobility, and wherein the RRC-L configuration is associated with an RRC-high (H) configuration generated by the CU for the UE.

13. The method of claim 12, wherein, to indicate the association between the RRC-L configuration and the RRC-H configuration:
the RRC-L configuration is transmitted in a same time period as the RRC-H configuration;
the RRC-L configuration is transmitted in an RRC-L message that also includes the RRC-H configuration;
the RRC-L configuration includes an RRC configuration identifier (ID) that is also included in the RRC-H configuration;
the RRC-L configuration includes an RRC-H ID of the RRC-H configuration; or
the RRC-L configuration includes one or more parameters of the RRC-H configuration.

14. The method of claim 12, wherein the RRC-L configuration is a first RRC-L configuration, and wherein the method further comprises:
generating, for transmission to the UE, a set of RRC-L configurations that includes the first RRC-L configuration, the set of RRC-L configurations associated with the RRC-H configuration; and
generating, for transmission to the UE, a message to activate the first RRC-L configuration from among the set of RRC-L configurations.

15. The method of claim 12, further comprising receiving assistance information from the CU, wherein the assistance information includes quality of service (QoS) requirements for the RRC-L configuration, and wherein the RRC-L configuration is generated based on the assistance information.

16. The method of claim 12, further comprising:
receiving a request message from the UE to request access to a network;
performing access control to determine whether the UE is allowed to access the network; and
generating a response for transmission to the UE based on the determination.

17. The method of claim 12, wherein the RRC-L configuration includes the configuration information related to intra-DU mobility, and wherein the method further comprises:
receiving intra-DU measurement results from the UE based on the configuration information related to intra-DU mobility;
determining to perform a handover of the UE to a target cell based on the intra-DU measurement results; and
generating a message for transmission to the UE to trigger the handover.

18. An apparatus comprising:
processor circuitry to:
receive an RRC-high (H) configuration from a centralized unit (CU);
receive an RRC-low (L) configuration which is generated by a distributed unit (DU), wherein the RRC-L configuration is associated with the RRC-H configuration;
update a full RRC configuration based on receipt of both the RRC-H configuration and the RRC-L configuration; and
communicate with a network based on the full RRC configuration; and
interface circuitry coupled to the processor circuitry to enable communication.

19. The apparatus of claim 18, wherein, to indicate the association between the RRC-L configuration and the RRC-H configuration:
the RRC-H configuration and the RRC-L configuration are transmitted in a same time period;
the RRC-H configuration is included in an RRC-L message that also includes the RRC-L configuration;
the RRC-H configuration and the RRC-L configuration include a same RRC configuration identifier (ID);
the RRC-L configuration includes an RRC-H ID of the RRC-H configuration; or
the RRC-L configuration includes one or more parameters of the RRC-H configuration.

20. The apparatus of claim 18, wherein the RRC-H configuration includes radio bearer configuration information for a first layer 2 (L2) protocol stack deployed in the CU and inter-CU mobility information, and the RRC-L configuration includes radio bearer configuration information for a second L2 protocol stack deployed in the DU and intra-CU mobility information.
